(19) United States
(12) Patent Application Publication
(10) Pub. No.: US 2025/0202609 A1
(43) Pub. Date: Jun. 19, 2025

(54) FINE TIME MEASUREMENT MESSAGING IN MULTI-LINK OPERATION

(71) Applicant: Cisco Technology, Inc., San Jose, CA (US)

(72) Inventors: Ardalan ALIZADEH, Campbell, CA (US); Peiman AMINI, Fremont, CA (US); Matthew A. SILVERMAN, Shaker Heights, OH (US); Sachin D. WAKUDKAR, St-Sulpice (CH); Jerome HENRY, Pittsboro, NC (US)

(21) Appl. No.: 18/597,737

(22) Filed: Mar. 6, 2024

Related U.S. Application Data
(60) Provisional application No. 63/612,304, filed on Dec. 19, 2023.

(51) Int. Cl. H04J 3/06; H04W 56/00

(52) U.S. Cl. CPC H04J 3/0667; H04W 56/001

(57) ABSTRACT

Techniques for determining a range between a first wireless station (STA) and a second STA. These techniques include identifying a mode for multi-link fine time measurement (FTM) from the first STA to the second STA, wherein the first STA includes a multi-link device (MLD) with a plurality of wireless links to the second STA. The techniques further include conducting FTM polling and sounding using at least two of the plurality of wireless links. This includes conducting FTM polling using a first one or more of the plurality of wireless links, based on the identified mode, and conducting FTM sounding using a second one or more of the plurality of wireless links, based on the identified mode. The techniques further include determining a range between the first STA and the second STA based on the FTM polling and sounding.

### CROSS-REFERENCE TO RELATED APPLICATIONS

This application claims benefit of co-pending U.S. provisional patent application Ser. No. 63/612,304 filed Dec. 19, 2023. The aforementioned related patent application is herein incorporated by reference in its entirety.

### TECHNICAL FIELD

Embodiments presented in this disclosure generally relate to wireless communications. More specifically, one or more embodiments disclosed herein relate to determining device positioning using fine time measurement (FTM).

### BACKGROUND

FTM techniques can allow an initiating wireless station (STA) to perform ranging against a responding STA, and compute the relative positions. The STAs can each be any suitable wireless device, including a laptop computer, a smartphone, a tablet, an internet of things (IoT) device, a vehicle, a drone, another suitable user device, or a wireless network infrastructure device (e.g., a wireless access point (AP)). For example, at least one of the STAs can be an AP, which participates in the ranging process by time-stamping wireless messages as needed and negotiating range parameters, including burst size, burst frequency, and others. In one example, the AP can time-stamp physical layer convergence protocol (PLCP) protocol data units (PPDUs).

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a computing environment for multi-link FTM, according to one embodiment.

FIG. 2 illustrates an STA and an AP for multi-link FTM, according to one embodiment.

FIG. 3 is a flowchart illustrating multi-link FTM, according to one embodiment.

FIG. 4 illustrates synchronized polling for multi-link FTM, according to one embodiment.

FIG. 5 illustrates measurement reporting for multi-link FTM, according to one embodiment.

FIG. 6 illustrates an example multi-link FTM request frame, according to one embodiment.

FIG. 7 is a flowchart illustrating synced FTM for multi-link FTM, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

Embodiments include a method. The method includes identifying a mode for multi-link fine time measurement (FTM) from a first wireless station (STA) to a second STA, wherein the first STA includes a multi-link device (MLD) with a plurality of wireless links to the second STA. The method further includes conducting FTM polling and sounding using at least two of the plurality of wireless links. This includes conducting FTM polling using a first one or more of the plurality of wireless links, based on the identified mode, and conducting FTM sounding using a second one or more of the plurality of wireless links, based on the identified mode. The method further includes determining a range between the first STA and the second STA based on the FTM polling and sounding.

Embodiments further include a system, including one or more processors and one or more memories storing a program, which, when executed on any combination of the one or more processors, performs operations. The operations include identifying a mode for multi-link fine time measurement (FTM) from a first wireless station (STA) to a second STA, wherein the first STA includes a multi-link device (MLD) with a plurality of wireless links to the second STA. The operations further include conducting FTM polling and sounding using at least two of the plurality of wireless links. This includes conducting FTM polling using a first one or more of the plurality of wireless links, based on the identified mode, and conducting FTM sounding using a second one or more of the plurality of wireless links, based on the identified mode. The operations further include determining a range between the first STA and the second STA based on the FTM polling and sounding.

Embodiments further include a non-transitory computer-readable medium containing computer program code that, when executed by operation of one or more computer processors, performs operations. The operations include identifying a mode for multi-link fine time measurement (FTM) from a first wireless station (STA) to a second STA, wherein the first STA includes a multi-link device (MLD) with a plurality of wireless links to the second STA. The operations further include conducting FTM polling and sounding using at least two of the plurality of wireless links. This includes conducting FTM polling using a first one or more of the plurality of wireless links, based on the identified mode, and conducting FTM sounding using a second one or more of the plurality of wireless links, based on the identified mode. The operations further include determining a range between the first STA and the second STA based on the FTM polling and sounding.

### Example Embodiments

Typically, FTM is performed at a per-link level, and not at a multi-link device (MLD) level. For example, an FTM responder (FTMR) and location measurement report (LMR) used in FTM, are tied to the per-link level and not MLD. While per-link FTM can be used to overcome some ranging error measurements, operating at a per-link level is generally not optimal in an MLD environment. Instead, FTM can be improved by adding multi-link capability to support MLD more efficiently.

For example, one or more techniques discussed below can reduce ranging measurement time (e.g., when faced with imbalanced channel bandwidth assignment for MLDs) by utilizing one MLD link (e.g., a lower bandwidth MLD link) for reporting and polling, and another MLD link (e.g., a higher bandwidth MLD link) for sounding. This can reduce the overhead of transmitting short control frames, particularly given the number of sounding bursts typical for FTM, and can significantly enhance the overall efficiency and accuracy of ranging, particularly in dense environments.

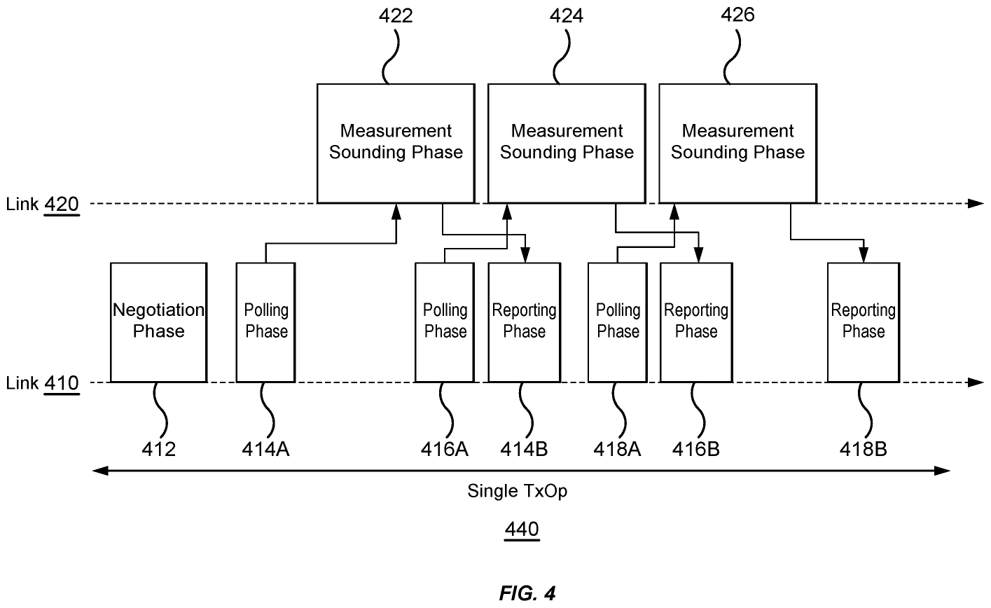

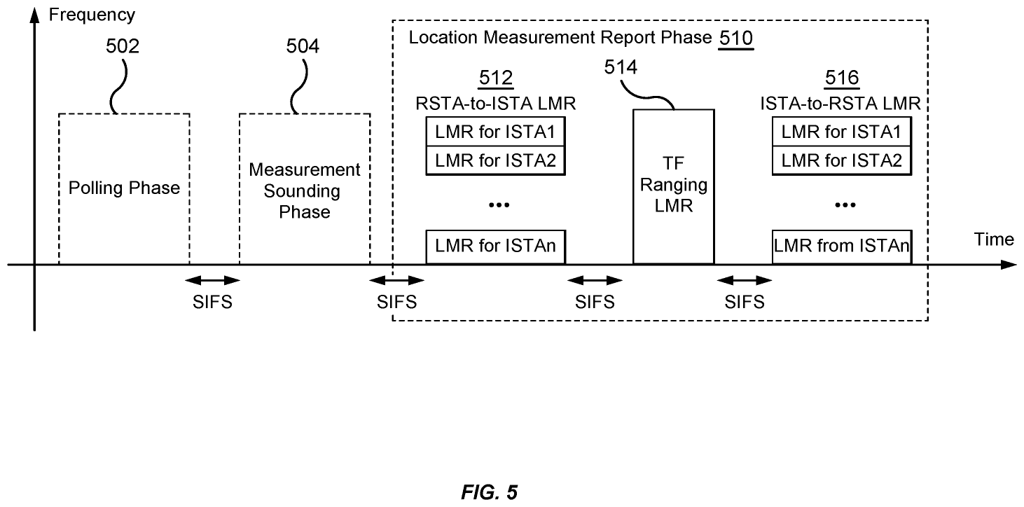

In an embodiment, assume a MLD device has a 6 GHz link and a 5 GHz link. The 6 GHz band is typically assigned a larger bandwidth (e.g., 160 MHz or even 320 MHz). Given this larger bandwidth for the 6 GHz link, extra measurement using the 5 GHz band (e.g., with 40 MHz or 80 MHz bandwidth) is unlikely to significantly enhance the overall accuracy of FTM sounding. Thus, the larger bandwidth link, alone, can be used for sounding with minimal impact on accuracy, while the smaller bandwidth link is used for reporting and polling, to improve efficiency and reduce latency and ranging time. This is discussed further, below, with regard to FIGS. 4-5.

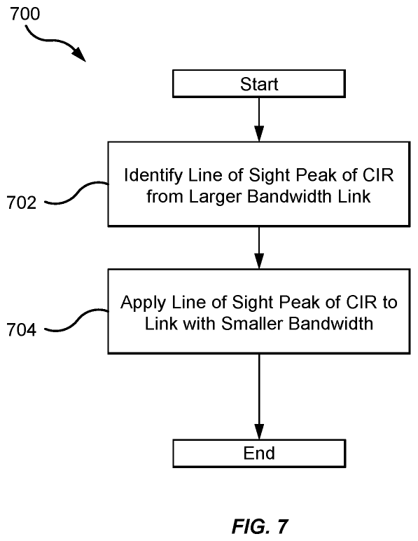

Alternatively, or in addition, when multiple links (e.g., multiple MLD links) are performing FTM measurements, these links can be combined and synchronized to further improve the maximum range of the FTM (e.g., by using the committed information rate (CIR) of the link with the larger bandwidth). While using both the higher and lower bandwidth link for sounding typically has minimal impact on accuracy (e.g., as discussed above), synchronizing link transmissions can have a significant impact on maximum range. For example, lower bandwidth links often perform more efficiently in terms of coverage and max range of measurement because of lower attenuation and higher power. Thus, the higher and lower bandwidth links can be synchronized to improve maximum range. This is discussed further, below, with regard to FIG. 7. In sum, in an embodiment multiple links can be used to improve both single-link FTM measurement (e.g., by using one link for reporting and polling and another for sounding to improve latency and efficiency) and dual-link FTM measurement (e.g., by synchronizing links for sounding to improve maximum range).

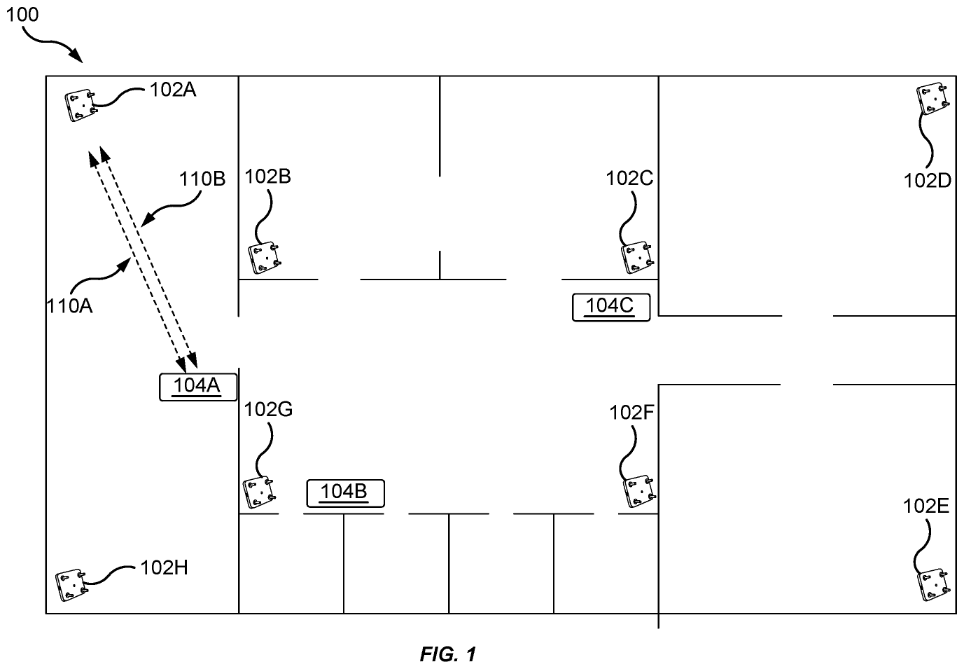

FIG. 1 illustrates a computing environment 100 for multi-link FTM, according to one embodiment. In an embodiment, the computing environment 100 includes a number of APs 102A-H and a number of STAs 104A-C. Each STA 104A-C can determine its range from the APs using FTM techniques (e.g., by exchanging timestamped messages). Further, in an embodiment, one or more of the APs 102A-H and STAs 104A-C support multi-link operation (MLO). For example, the AP 102A can be a MLD and can be associated with the STA 104A using a higher bandwidth link 110A and a lower bandwidth link 110B. As one example, the AP 102A can support a 6 GHz band (e.g., in addition to 2.4 GHz and 5 GHz bands), and the 6 GHz band can be allocated larger bandwidth than other connections (e.g., 160 Hz or 320 Hz).

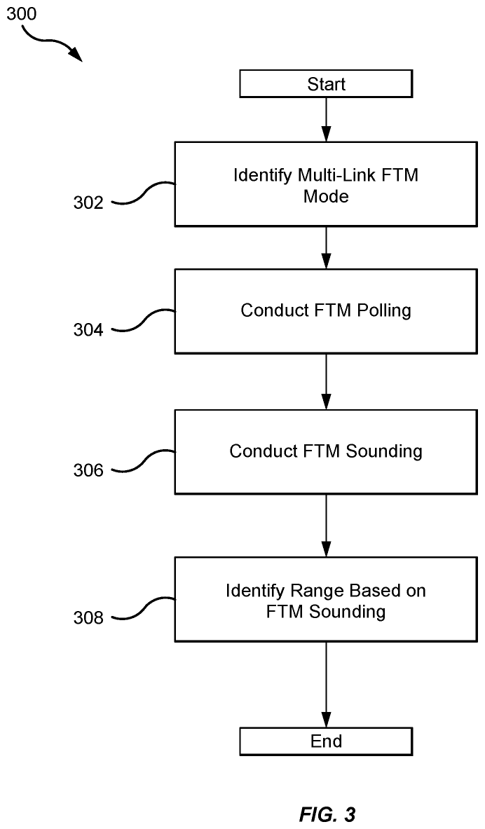

In an embodiment, the AP 102A can use these multiple links 110A and 110B to facilitate FTM. For example, as discussed below, the AP 102A can use one link for sounding (e.g., the higher bandwidth link 110A) and another link for polling and reporting (e.g., the lower bandwidth link 110B). This is discussed further, below, with regard to FIGS. 3-6. In an embodiment, this can reduce the time needed for ranging, reduce the overhead of transmitting control frames, and provide many other improvements.

As discussed above, in one example the AP 102A can use the multiple links 110A and 110B for FTM by dividing sounding and polling/reporting between the links. But this is merely one option. As another example, the AP 102A can use both links (e.g., the links 110A and 110B) for synchronized link transmission for FTM. This is discussed further, below, with regard to FIG. 7. In an embodiment, synchronized link transmission with both links can significantly improve the maximum range of FTM.

In an embodiment, positioning information determined using FTM can be used by the STAs for a number of management purposes, including selecting an AP for connection and configuring a variety of radio transmission and other parameter. The positioning information can also be used for numerous application purposes, including augmented reality, social networking, health care monitoring, inventory control, etc.

While FIG. 1 focuses on the use of APs and STAs for wireless radio communication, this is merely an example. Any suitable orchestrating device can be used, in place of or in addition to an AP (e.g., a suitable wireless controller). Further, any transmission technology could be used, including laser light, radio transmissions in additional spectrum (e.g., outside of the WiFi spectrum), or any other suitable transmission.

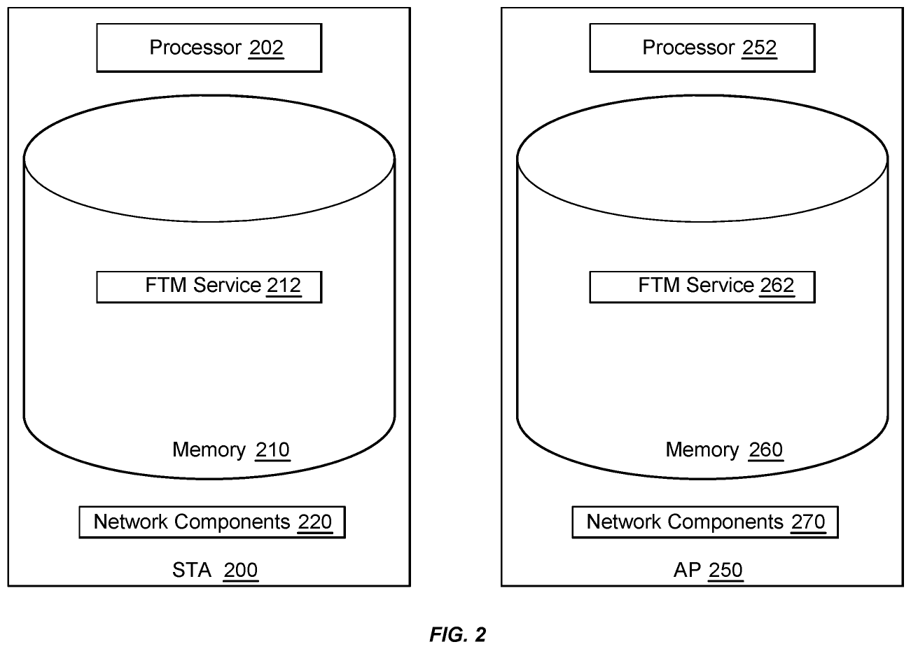

FIG. 2 illustrates an STA 200 and an AP 250 for multi-link FTM, according to one embodiment. In an embodiment, the STA 200 corresponds with any of the STAs 104A-C illustrated in FIG. 1. The STA 200 includes a processor 202, a memory 210, and network components 220. The processor 202 generally retrieves and executes programming instructions stored in the memory 210. The processor 202 is included to be representative of a single central processing unit (CPU), multiple CPUs, a single CPU having multiple processing cores, graphics processing units (GPUs) having multiple execution paths, and the like.

The network components 220 include the components necessary for the STA 200 to interface with a wireless communication network, as discussed above in relation to FIG. 1. For example, the network components 220 can include WiFi or cellular network interface components and associated software.

Although the memory 210 is shown as a single entity, the memory 210 may include one or more memory devices having blocks of memory associated with physical addresses, such as random access memory (RAM), read only memory (ROM), flash memory, or other types of volatile and/or non-volatile memory. The memory 210 generally includes program code for performing various functions related to use of the STA 200. The program code is generally described as various functional “applications” or “modules” within the memory 210, although alternate implementations may have different functions and/or combinations of functions.

Within the memory 210, an FTM service 212 facilitates multi-link FTM, as discussed below in relation to FIGS. 3-7. FTM is merely one example of a suitable range finding technique, and other techniques can be used. The FTM service 212 facilitates identifying the range of the STA 200 from an AP (e.g., the AP 250) and facilitates identifying the location of the STA 200 using the range information.

The AP 250 includes a processor 252, a memory 260, and network components 270. The processor 252 generally retrieves and executes programming instructions stored in the memory 260. The processor 252 is included to be representative of a single central processing unit (CPU), multiple CPUs, a single CPU having multiple processing cores, graphics processing units (GPUs) having multiple execution paths, and the like.

The network components 270 include the components necessary for the AP 250 to interface with a wireless communication network, as discussed above in relation to FIG. 1. For example, the network components 270 can include WiFi or cellular network interface components and associated software.

Although the memory 260 is shown as a single entity, the memory 260 may include one or more memory devices having blocks of memory associated with physical addresses, such as random access memory (RAM), read only memory (ROM), flash memory, or other types of volatile and/or non-volatile memory. The memory 260 generally includes program code for performing various functions related to use of the AP 250. The program code is generally described as various functional “applications” or “modules” within the memory 260, although alternate implementations may have different functions and/or combinations of functions. Within the memory 260, the FTM service 262 facilitates multi-link FTM, as discussed below in relation to FIGS. 3-7.

FIG. 3 is a flowchart 300 illustrating multi-link FTM, according to one embodiment. In an embodiment, an FTM service for an initiating station (ISTA) (e.g., the FTM service 212 or the FTM service 262 illustrated in FIG. 2) identifies a multi-link FTM mode. For example, where multi-link connections are available, an ISTA can operate in any of several modes. In an embodiment, the ISTA uses a multi-link element exchange to identify which modes of operation are available.

In an embodiment, these modes include independent links (e.g., where each link measures independently). For example, existing solutions can use independent links. Further, the modes can include synced FTM, in which synced transmission of sounding frames (e.g., synced between links) enables combined CIR usage of the multi-links. This is discussed further, below, with regard to FIG. 7. In an embodiment, the modes can also include single-link sounding, in which one link (e.g., a higher bandwidth link) is used for sounding, while another link (e.g., a lower bandwidth link) is used for polling and reporting. This is discussed, further, below with regard to FIGS. 4-5. These modes are merely examples, and the FTM service can use any suitable mode(s). Further, the FTM service can be configured to always operate in a particular mode.

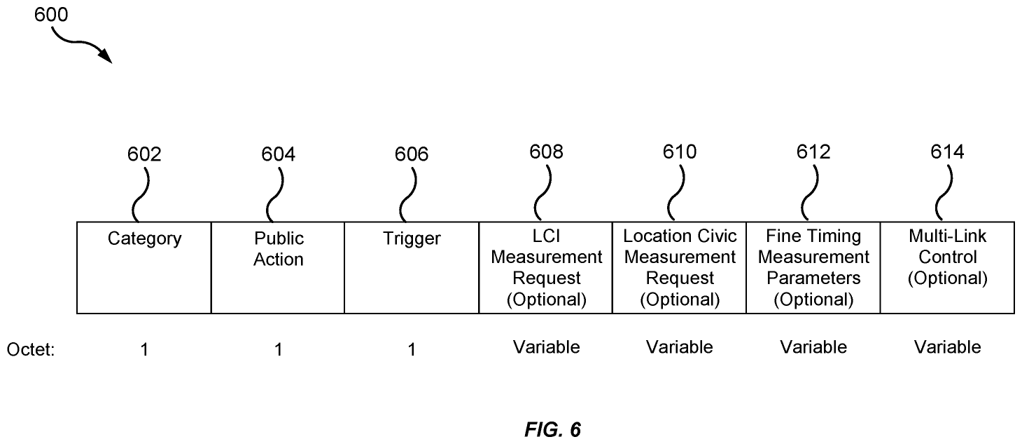

In an embodiment, the ISTA identifies the mode per FTM session in the negotiation phase. For example, an FTM request frame can include an extra field (e.g., a multi-link control subfield) identifying the multi-link FTM mode. This is discussed further, with regard to FIG. 6. This is merely an example, and the ISTA can identify the mode using any suitable technique.

At block 304, the FTM service conducts FTM polling. For example, the FTM service can operate in single-link sounding mode, and can use a lower bandwidth link for FTM polling. This is illustrated, below, with regard to FIG. 4. This is merely an example, and the FTM service can also operate in a synced FTM mode, in which both links (e.g., separately or together) are used for polling, in independent link mode (e.g., in which the links conduct FTM polling independently), or any other suitable mode.

At block 306, the FTM service conducts sounding. For example, the FTM service can operate in single-link sounding mode, and can use a higher bandwidth link for FTM sounding. This is illustrated, below, with regard to FIG. 4. This is merely an example, and the FTM service can also operate in a synced FTM mode, in which both links are used for sounding. For example, as discussed below in relation to FIG. 7, the synchronized links can be used increase the range for sounding. As another example, the FTM service can operate in independent link mode (e.g., in which the links conduct FTM sounding independently), or any other suitable mode.

At block 308, the FTM service identifies the range based on the FTM sounding. For example, the FTM service can use a measurement report to identify the range (e.g., a measurement report generated using FTM techniques). In an embodiment, when operating in single-link sounding mode the measurement report is transmitted using the lower bandwidth link. This is discussed further, below, with regard to FIG. 5. Alternatively, or in addition, when operating in synced FTM mode the measurement report can be sent by both links (e.g., independently or together), and when operating in independent link mode the measurement report can be sent by both links independently.

FIG. 4 illustrates synchronized polling for multi-link FTM, according to one embodiment. In an embodiment, FIG. 4 corresponds with single-link sounding mode for multi-link FTM, as discussed above in relation to FIG. 3. In an embodiment, an ISTA has a multi-link connection to a response station (RSTA). For example, the ISTA can maintain a higher bandwidth link 420 (e.g., a 6 GHz link) to an RSTA, and a lower bandwidth link 410 (e.g., a 2.4 GHz or 5 GHz link) to the RSTA. The ISTA can conduct polling and reporting using the lower bandwidth link 410, and can conduct sounding using the higher bandwidth link 420.

As illustrated, an FTM service for the ISTA (e.g., the FTM service 212 or the FTM service 262 illustrated in FIG. 2) begins with a negotiation phase 412. As discussed above in relation to FIG. 3, in an embodiment the FTM service identifies a multi-link FTM mode during the negotiation phase 412 (e.g., a single-link sounding mode, a synced FTM mode, an independent FTM mode, or any other suitable multi-link FTM mode). For example, the FTM service identifies the mode, per FTM session in the negotiation phase, using a field in an FTM request frame (e.g., as illustrated below in FIG. 6). This is merely an example.

As illustrated in FIG. 4, the FTM service operates in single-link sounding mode. Thus, the FTM service conducts a polling phase 414A using the lower bandwidth link 410, while the FTM service conducts a measurement sounding phase 422 using the higher bandwidth link 420. The FTM service conducts a reporting phase 414B using the lower bandwidth link 410. In an embodiment, this is true for any suitable number of phases (e.g., any suitable number of polling, measurement, and reporting phases).

For example, the FTM service can conduct polling phases 416A and 418A, and reporting phases 416B and 418B, using the lower bandwidth link 410. The FTM service can conduct measurement sounding phases 424 and 426 using the higher bandwidth link 420. While a burst of three measurement sounding phases 422, 424, and 426 is illustrated in a single TxOp 440, this is merely an example for illustration. In an embodiment, a burst of any suitable number of phases can be used (e.g., a burst of eight measurement phases, along with corresponding polling and reporting phases).

FIG. 5 illustrates measurement reporting for multi-link FTM, according to one embodiment. In an embodiment, FIG. 5 illustrates multi-link FTM with more detail of a location measurement report phase 510). For example, a polling phase 502 (e.g., any of the polling phases 414A, 416A, or 418A illustrated in FIG. 4) is followed by a measurement sounding phase (e.g., any of the measurement sounding phases 422, 424, or 428 illustrated in FIG. 4). In an embodiment, if a FTM service for an ISTA (e.g., the FTM service 212 or the FTM service 262 illustrated in FIG. 2) operates in a single-link sounding mode, the FTM service conducts the polling phase 502 using one link (e.g., a lower bandwidth link) and the measurement sounding phase 504 using another link (e.g., a higher bandwidth link).

The FTM service then conducts a location measurement report phase 510. In an embodiment, the location measurement report phase 510 can be relatively burdensome (e.g., take a long time relative to the overall time for FTM bursts). Thus, when operating in a single-link sounding mode the FTM service can conduct the location measurement report phase 510 using the lower bandwidth link, which frees the higher bandwidth link up for additional measurement sounding phases. For example, an FTM service on an RSTA can send an RSTA to ISTA location measurement report 512 to an ISTA using the lower bandwidth link. An FTM service (e.g., on the RSTA) can further generate a trigger frame (TF) ranging LMR 514. Finally, an FTM service on an ISTA can send an ISTA to RSTA LMR 516 to an RSTA using the lower bandwidth link.

While FIG. 5 illustrates one ISTA and one RSTA, this is merely an example. Any suitable number of RSTAs can be used. For example, the FTM service can analyze channel impulse response from multiple RSTAs, and use a peak to identify a time difference between responses (e.g., for the FTM ranging).

FIG. 6 illustrates an example multi-link FTM request frame, according to one embodiment. As illustrated, a first octet 602 identifies a category, a second octet 604 identifies a public action, and a third octet 606 identifies a trigger. Further, variable octet(s) 608 identify an optional location configuration information (LCI) measurement request, variable octet(s) 610 identify an optional location civic measurement request, and variable octet(s) 612 identify optional FTM parameters). In an embodiment, the octets 602, 604, 606, 608, 610, and 612 correspond with existing FTM request frame techniques.

In an embodiment, a multi-link FTM request frame 600 adds additional variable octet(s) 614. These octets 614 identify multi-link control. For example, the octets 614 can identify a multi-link FTM mode as discussed above in relation to block 302 illustrated in FIG. 3. The multi-link FTM mode can include a single link sounding mode (e.g., as discussed above in relation to FIGS. 4-5), a synced FTM mode (e.g., as discussed below in relation to FIG. 7), an independent link mode (e.g., as used by existing solutions), or any other suitable multi-link FTM mode. This is merely an example, and the multi-link FTM mode can be identified using suitable technique.

FIG. 7 is a flowchart 700 illustrating synced FTM for multi-link FTM, according to one embodiment. As discussed above, in some MLD scenarios it is advantageous to use single-link sounding (e.g., with the higher bandwidth link used for sanding and a lower bandwidth link used for reporting and polling). But this is not always preferred. Lower frequency bands typically perform more efficiently in terms of coverage and maximum range of measurement, because of lower attenuation and higher power. Therefore it can be beneficial to use a synced FTM in which multiple links are synchronized and used for sounding. This can significantly improve the maximum range of the sounding.

At block 702 an FTM service (e.g., the FTM service 212 or the FTM service 262 illustrated in FIG. 2) identifies a line of site peak of CIR from a larger bandwidth link. In an embodiment, the FTM service can consider the higher resolution of CIR in the link with larger bandwidth (e.g., a 6 GHz link), and can identify the line of sight peak of CIR from the link with larger bandwidth.

At block 704, the FTM service applies the line of site peak of CIR to the link with the smaller bandwidth. In an embodiment, the FTM service identifies the line of site peak from the larger bandwidth link at block 702, and then applies the line of site peak to the lower bandwidth link, for synchronized transmission (e.g., synchronized sounding transmission). In an embodiment, orthogonal frequency division multiple access (OFDMA) can be used to combine multiple CIR transmissions.

Alternatively, or in addition, the FTM service interpolates the CIR of the link with lower bandwidth, and merges it with the high resolution CIR from other link. This merging mechanism can be based on any suitable technique, including a weighted average in which the weights are determined from received signal strength indicator (RSSI), signal-to-noise ratio (SNR), or any other suitable characteristic of each link. This is merely an example, and any suitable technique can be used.

Further, in an embodiment the links do not need to be synchronized precisely (e.g., using hardware). Synchronizing the links so that transmission occurs roughly simultaneously (e.g., at least partially simultaneously) is typically sufficient. For example, the FTM service can use a software trigger based mechanism for synchronization (e.g., without requiring a hardware oscillator or another more precise technique).

In an embodiment, this synchronization can significantly improve the maximum range of transmission (e.g., sounding transmission) by providing an accurate marker to the low resolution CIR. This comes from the fact that the receiver is not limited by the sensitivity of decoding the payload of the FTM Ranging Frames, and any combination of long training field (LTF), channel state information (CSI), or CIR extraction from the frame is enough.

As illustrated, the embodiments described above in relation to FIGS. 1-7 focus on two links (e.g., a combination of 6 GHZ, 5 GHZ, and 2.4 GHz links). But this is merely an example for ease of illustration. Alternatively, or in addition, more than two links could be used. Further, multiple links could be used within the same radio transmission spectrum (e.g., multiple 6 GHz links, multiple 5 GHz links, multiple 2.4 GHz links, or multiple links within any other suitable radio transmission spectrum). And, as noted, 6 Ghz, 5 Ghz, and 2.4 GHz are merely examples, and any suitable radio transmission spectrum can be used.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
identifying a mode for multi-link fine time measurement (FTM) from a first wireless station (STA) to a second STA, wherein the first STA comprises a multi-link device (MLD) with a plurality of wireless links to the second STA;
conducting FTM polling and sounding using at least two of the plurality of wireless links, comprising:
conducting FTM polling using a first one or more of the plurality of wireless links, based on the identified mode; and
conducting FTM sounding using a second one or more of the plurality of wireless links, based on the identified mode; and
determining a range between the first STA and the second STA based on the FTM polling and sounding.

2. The method of claim 1,
wherein the at least two of the plurality of wireless links comprises a first link, and a second link different from the first link,
wherein conducting the FTM polling comprises transmitting one or more FTM polling messages from the first STA to the second STA using the first link and not the second link, and
wherein conducting the FTM sounding comprises transmitting one or more FTM sounding messages from the first STA to the second STA using the second link and not the first link.

3. The method of claim 2, further comprising:
receiving one or more FTM reporting messages using the first link and not the second link.

4. The method of claim 3, wherein the second link comprises a higher bandwidth link relative to the first link.

5. The method of claim 4, wherein the second link comprises a 6 GHz link and the first link comprises at least one of a 5 GHz link or a 2.4 GHz link.

6. The method of claim 1, wherein conducting FTM sounding using the second one or more of the plurality of wireless links, based on the identified mode, comprises:
synchronizing transmission of one or more FTM sounding messages using both of the at least two of the plurality of wireless links.

7. The method of claim 6, wherein synchronizing transmission of one or more FTM sounding messages using both of the at least two of the plurality of wireless links comprises:
using a committed information rate (CIR) of a link with larger bandwidth, among the at least two of the plurality of wireless links, for synchronizing transmission.

8. The method of claim 7, wherein using the CIR of the link with the larger bandwidth, among the at least two of the plurality of wireless links, for synchronizing transmission, comprises:
identifying a line of site peak of CIR from the link with the larger bandwidth; and
applying the line of site peak of CIR to a link with a smaller bandwidth, among the at least two of the plurality of wireless links.

9. The method of claim 1, further comprising:
determining the mode for multi-link FTM.

10. The method of claim 9, wherein determining the mode for multi-link FTM comprises:
parsing a field in an FTM request frame.

11. A system, comprising:
one or more processors; and
one or more memories storing a program, which, when executed on any combination of the one or more processors, performs operations, the operations comprising:
identifying a mode for multi-link fine time measurement (FTM) from a first wireless station (STA) to a second STA, wherein the first STA comprises a multi-link device (MLD) with a plurality of wireless links to the second STA;
conducting FTM polling and sounding using at least two of the plurality of wireless links, comprising:
conducting FTM polling using a first one or more of the plurality of wireless links, based on the identified mode; and
conducting FTM sounding using a second one or more of the plurality of wireless links, based on the identified mode; and
determining a range between the first STA and the second STA based on the FTM polling and sounding.

12. The system of claim 11,
wherein the at least two of the plurality of wireless links comprises a first link, and a second link different from the first link,
wherein conducting the FTM polling comprises transmitting one or more FTM polling messages from the first STA to the second STA using the first link and not the second link, and
wherein conducting the FTM sounding comprises transmitting one or more FTM sounding messages from the first STA to the second STA using the second link and not the first link.

13. The system of claim 12, the operations further comprising:
receiving one or more FTM reporting messages using the first link and not the second link, wherein the second link comprises a higher bandwidth link relative to the first link.

14. The system of claim 11, wherein conducting FTM sounding using the second one or more of the plurality of wireless links, based on the identified mode, comprises:
synchronizing transmission of one or more FTM sounding messages using both of the at least two of the plurality of wireless links.

15. The system of claim 14, wherein synchronizing transmission of one or more FTM sounding messages using both of the at least two of the plurality of wireless links comprises:
using a committed information rate (CIR) of a link with larger bandwidth, among the at least two of the plurality of wireless links, for synchronizing transmission.

16. A non-transitory computer-readable medium containing computer program code that, when executed by operation of one or more computer processors, performs operations comprising:
identifying a mode for multi-link fine time measurement (FTM) from a first wireless station (STA) to a second STA, wherein the first STA comprises a multi-link device (MLD) with a plurality of wireless links to the second STA;
conducting FTM polling and sounding using at least two of the plurality of wireless links, comprising:
conducting FTM polling using a first one or more of the plurality of wireless links, based on the identified mode; and
conducting FTM sounding using a second one or more of the plurality of wireless links, based on the identified mode; and
determining a range between the first STA and the second STA based on the FTM polling and sounding.

17. The non-transitory computer-readable medium of claim 16,
wherein the at least two of the plurality of wireless links comprises a first link, and a second link different from the first link,
wherein conducting the FTM polling comprises transmitting one or more FTM polling messages from the first STA to the second STA using the first link and not the second link, and
wherein conducting the FTM sounding comprises transmitting one or more FTM sounding messages from the first STA to the second STA using the second link and not the first link.

18. The non-transitory computer-readable medium of claim 17, the operations further comprising:
receiving one or more FTM reporting messages using the first link and not the second link, wherein the second link comprises a higher bandwidth link relative to the first link.

19. The non-transitory computer-readable medium of claim 16, wherein conducting FTM sounding using the second one or more of the plurality of wireless links, based on the identified mode, comprises:
synchronizing transmission of one or more FTM sounding messages using both of the at least two of the plurality of wireless links.

20. The non-transitory computer-readable medium of claim 19, wherein synchronizing transmission of one or more FTM sounding messages using both of the at least two of the plurality of wireless links comprises:
using a committed information rate (CIR) of a link with larger bandwidth, among the at least two of the plurality of wireless links, for synchronizing transmission.
